(19) United States
(12) Patent Application Publication
(10) Pub. No.: US 2021/0135202 A1
(43) Pub. Date: May 6, 2021

(54) COMPOSITE LAYER AND LITHIUM-BASED BATTERY HAVING THE SAME

(71) Applicant: National Taiwan University of Science and Technology, Taipei City (TW)

(72) Inventors: BING-JOE HWANG, Taipei City (TW); WEI-NIEN SU, Taipei City (TW); PING-CHUN TSAI, Tainan City (TW); DAO-YI WANG, New Taipei City (TW); CHORNG-SHYAN CHERN, Taipei City (TW)

(21) Appl. No.: 17/079,641

(22) Filed: Oct. 26, 2020

Related U.S. Application Data
(60) Provisional application No. 62/927,713, filed on Oct. 30, 2019.

(51) Int. Cl. H01M 4/36; H01M 10/052; H01M 10/0525; H01M 4/505; H01M 4/62

(52) U.S. Cl. CPC H01M 4/366; H01M 10/052; H01M 2004/028; H01M 4/505; H01M 4/628; H01M 10/0525

(57) ABSTRACT

A composite layer for use in a lithium-based battery is disclosed. The composite layer comprises a fibrous film and an inorganic additive, wherein there is a weight ratio of the fibrous film to the inorganic additive, and the weight ratio is in a range between 5:95 and 20:80. It is worth explaining that, by letting a lithium-based battery like Li metal battery be integrated with the proposed composite layer, not only does the formation of lithium dendrite be significantly suppressed, but the decomposition of electrolyte is also effectively inhibited. Moreover, the most important thing is that, by letting the lithium-based battery be integrated with the proposed composite layer, capacity retention and coulombic efficiency of the lithium-based battery are both significantly enhanced.

### CROSS-REFERENCE TO RELATED APPLICATION

This application claims the benefit of U.S. Provisional Patent Application No. 62/927,713, filed on Oct. 30, 2019, which is hereby incorporated by reference.

### BACKGROUND OF THE INVENTION

### 1. Field of the Invention

The present invention relates to the technology field of lithium-based batteries, and more particularly to a composite layer and a lithium-based battery including the forgoing composite layer.

### 2. Description of the Prior Art

With the enormous development of science and technology, demand for high-capacity energy storage devices is booming owing to the emergence of applications for electric vehicles and variety of electronic devices such as smartphone, tablet computer and laptop computer. Currently, the dominant energy storage device remains the battery, particularly the lithium-based batteries that are classified into lithium-ion battery (LIB) and lithium metal battery (LMB). As explained in more detail below, lithium has been regarded as the most promising anode material for high-energy-density batteries due to its extremely high theoretical gravimetric capacity of 3860 mAh·g⁻¹ (vs. graphite (372 mAh·g⁻¹)) along with its low electrochemical potential of −3.04 V.

FIG. 1 shows an exploded perspective view of one kind of commercial Li metal battery. From FIG. 1, it is understood that the Li metal battery 1′ is a coin cell battery, and comprises: a bottom cap 10′, a top cap 16′, a cathode material 17′, Al current collector 13′, a separator 12′ provided with electrolyte thereon, Li anode 11′, Cu current collector 14′, and spring member 15′. Engineers skilled in development and manufacture of lithium-based batteries certainly know that, Li metal battery 1′ may fail unexpectedly via short-circuiting through metallic dendrites that grow between electrodes upon recharging. Charging and discharging of lithium metal battery 1′ is achieved by a dissolution and deposition of lithium at the Li anode 11′. In this regard, the use of Li anode 11′ has an advantage that it is electrochemically efficient due to a uniform dissolution of lithium on discharging. However, use of Li anode 11′ also has a disadvantage that lithium metal grows and deposits in a dendrite shape (i.e., branch shape) on alternate repetition of charging and discharging, thus resulting in at least one inner short circuit so as to reduce the charge and discharge efficiency of the battery.

As stated above, the use of Li anode 11′ is the most preferable in terms of the electrochemical efficiency of a Li metal battery. However, the use of Li anode 11′ is significantly restricted due to the precipitation of lithium in the form of dendrite and a low efficiency upon charging and discharging. Further, a low reactivity in the form of lithium foil and the presence of a solid electrolyte interface (SEI) on the surface of the Li foil are believed to cause a voltage drop and a problem on high-rate discharging in a lithium primary battery, thereby causing the formation of inner short circuit, and more seriously, explosion of the whole Li metal battery 1′. In view of that, U.S. Pat. No. 666,850B2 discloses that letting the Li anode be covered by a polymeric coating is helpful in enhancing safety of the Li metal battery. However, it is a pity that relative experimental data have revealed that, the polymeric coating fails to exhibit chemical and mechanical properties. Moreover, ion conductivity and thermal stability of the polymeric coating is also found having yet to be improved.

From above descriptions, it is understood that there is still room for improvement in the conventional lithium-based battery. In view of that, inventors of the present application have made great efforts to make inventive research and eventually provided a composite layer and a lithium-based battery including the forgoing composite layer.

### SUMMARY OF THE INVENTION

The primary objective of the present invention is to disclose a composite layer for use in a lithium-based battery is disclosed. The composite layer comprises a fibrous film and an inorganic additive, wherein there is a weight ratio of the fibrous film to the inorganic additive, and the weight ratio is in a range between 5:95 and 20:80. It is worth explaining that, by letting a lithium-based battery like Li metal battery be integrated with the proposed composite layer, not only does the formation of lithium dendrite be significantly suppressed, but the decomposition of electrolyte is also effectively inhibited. Moreover, the most important thing is that, by letting the lithium-based battery be integrated with the proposed composite layer, capacity retention and coulombic efficiency of the lithium-based battery are both significantly enhanced.

In order to achieve the primary objective of the present invention, inventors of the present invention provide an embodiment for the composite layer for application in a lithium-based battery, and comprises a fibrous film and an inorganic additive, wherein there is a weight ratio of the fibrous film to the inorganic additive, and the weight ratio being in a range between 5:95 and 20:80.

Moreover, inventors of the present invention also provide an embodiment for a lithium-based battery which is characterized in that a composite layer is integrated in the lithium-based battery, and the composite layer comprises a fibrous film and an inorganic additive; wherein there is a weight ratio of the fibrous film to the inorganic additive, and the weight ratio being in a range between 5:95 and 20:80.

In one embodiment, the fibrous film comprises a plurality of polymer fibers, and the inorganic additive is doped in the plurality of polymer fibers, or being enclosed in each of the plurality of polymer fibers, thereby making the composite layer has a Young's modulus greater than 8 MPa.

In one embodiment, the composite layer further comprises a lithium salt, such that the composite layer is characterized by comprising a first part by mass of the fibrous film and the inorganic additive occupy and a second part by mass of the lithium salt, so as to make that there is a ratio between the second part by mass and the first part by mass, and the ratio being in a range from 1:4 to 1:100.

In one embodiment, the lithium-based battery is an anode free lithium metal battery (AFLMB), and the composite layer is disposed on a current collector of the anode free lithium metal battery. In which, the current collector is made of a material that is selected from the group consisting of stainless steel, Cu, Al, Ag, alloy containing indium, and fluorine-doped tin oxide (FTO).

In one embodiment, the lithium-based battery is a lithium-ion battery, and the composite layer is disposed on a lithium manganese oxide (LMO) cathode of the lithium-ion battery, so as to be used as a cathode-electrolyte interphase (CEI).

In one embodiment, the fibrous film is made of a material that is selected from the group consisting of polyvinylidene fluoride (PVDF), polyacrylonitrile (PAN) and pyethylene oxide (PEO).

In one embodiment, the composite layer further comprises an organic member, and the organic member is made of an oligomer with thermal polymerization property that is selected from the group consisting of monomaleimide, polymaleimide, bismaleimide, polybismaleimide, and copolymer of bismaleimide and monomaleimide.

In one embodiment, the inorganic additive comprises a first material that is selected from the group consisting of Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows an exploded perspective view of one kind of commercial Li metal battery;

FIG. 2 shows a schematic exploded perspective view of a lithium-based battery integrated with a composite layer according to the present invention;

FIG. 3 shows an experimental data plot of a tensile test of the composite layer according to the present invention;

FIG. 4 shows a data plot of capacity versus voltage of a sample No. 3 of the lithium-based battery integrated with the composite layer;

FIG. 5 shows a data plot of capacity versus voltage of a sample No. 4 of the lithium-based battery integrated with the composite layer;

FIG. 6 shows a data plot of capacity versus voltage of a sample No. 5 of the lithium-based battery integrated with the composite layer;

FIG. 7 shows an experimental data plot of an electrical test of the sample No. 3, the sample No. 4 and the sample No. 5;

FIG. 8 shows an experimental data plot of a charge/discharge cycle test of a sample No. I and a sample No. II of the lithium-based battery integrated with the composite layer; and

FIG. 9 shows an experimental data plot of an electrical test of the sample No. I and the sample No. II.

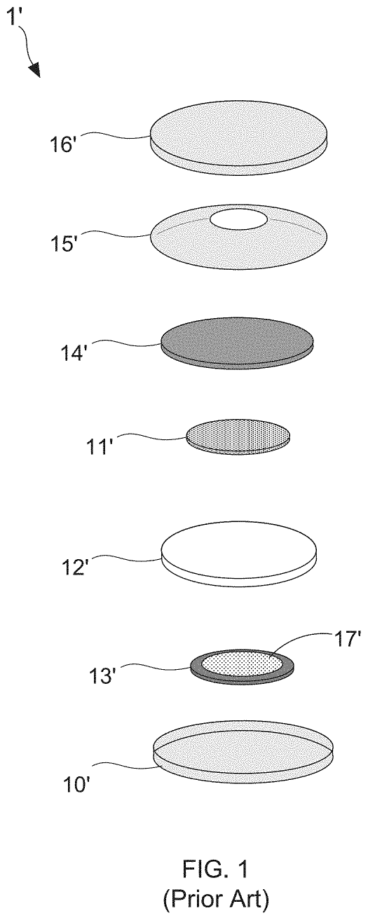

### DETAILED DESCRIPTION OF THE PREFERRED EMBODIMENTS

To more clearly describe a composite layer and a lithium-based battery including the forgoing composite layer disclosed by the present invention, embodiments of the present invention will be described in detail with reference to the attached drawings hereinafter.

### First Embodiment

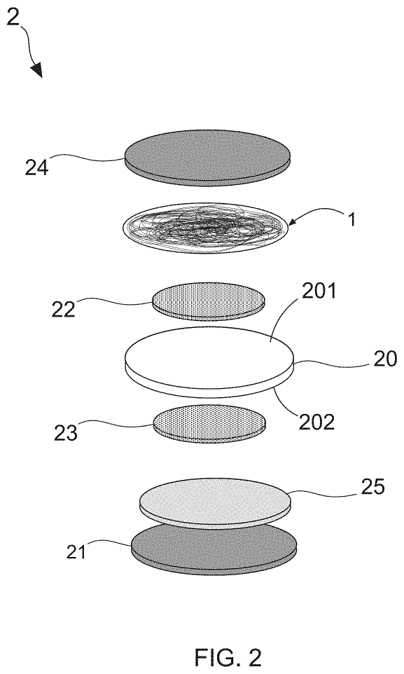

With reference to FIG. 2, there is shown a schematic exploded perspective view of a lithium-based battery integrated with a composite layer according to the present invention. In first embodiment, the lithium-based battery 2 is an anode free lithium metal battery (AFLMB), and comprises: a copper current collector 24, a first electrolyte 22, a separator 20, a second electrolyte 23, a cathode material 25, and an aluminum current collector 21. From FIG. 2, it is understood that the first electrolyte 22 and the second electrolyte 23 are disposed on a first surface 201 and a second surface 202 of the separator 20, respectively. It is worth noting that, the composite layer 1 of the present invention is disposed on the copper current collector 24, so as to be located between the copper current collector 24 and the first electrolyte 22 disposed on the first surface 201 of the separator 20.

Herein, it needs to further emphasize that, the lithium-based battery 2 depicted by FIG. 2 is adopted for assisting in explanation of an exemplary application of the composite layer 1 of the present invention. The structural framework of the lithium-based battery 2 depicted by FIG. 2 is not used for being as a structure limitation for the lithium-based battery 2 that is integrated with the composite layer 1 of the present invention therein. In a practicable embodiment, the current collector can be made of a material, and the material can be stainless steel, copper (Cu), aluminum (Al), silver (Ag), alloy containing indium, or fluorine-doped tin oxide (FTO). In which, an example for the alloy containing indium is copper-indium alloy. Moreover, in the first embodiment, both the first the first electrolyte 22 and the second electrolyte 23 are an electrolyte solution made by letting 1M LiPF₆ be dissolved in an organic solution. A principal material of the organic solution can be ethylene carbonate (EC), diethyl carbonate (DEC), 4-fluoroethylene carbonate, or a mixture of two or more of the forgoing materials. For instance, the organic solution is prepared after mixing EC with DEC by a ratio of 1:1 (v/v).

As described in more detail below, the composite layer 1 of the present invention comprises a fibrous film and an inorganic additive, wherein there is a weight ratio of the fibrous film to the inorganic additive, and the weight ratio is in a range between 5:95 and 20:80. In a practicable embodiment, the fibrous film is made of a material selected from the group consisting of polyvinylidene fluoride (PVDF), polyacrylonitrile (PAN) and pyethylene oxide (PEO), and comprises a plurality of polymer fibers. On the other hand, the inorganic additive is a powder of cubic lithium garnet material, and is doped in the plurality of polymer fibers, or is enclosed in each of the plurality of polymer fibers, thereby making the composite layer 1 has a Young's modulus greater than 8 MPa.

In a practicable embodiment, the powder of cubic lithium garnet material (i.e., the inorganic additive) comprises a first inorganic material and a second inorganic material. In which, the first inorganic material can be Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials. On the other hand, the second inorganic material can be Al, Nb, Ca, Ta, Ga, Zr, or W. For instance, the powder of cubic lithium garnet material (i.e., the inorganic additive) is Li₇La_{2.75}Ca_{0.25}Zr_{1.75}Nb_{0.25}O₁₂ (LLCZN) or Li_{5.6}Ga_{0.26}La_{2.9}Zr_{1.87}Nb_{0.05}O₁₂ (LGLZNO). The processing flow for manufacturing the LLCZN comprises following steps:
(1) preparing a powder containing LiNO₃, La(NO₃)₃, ZrO(NO₃)₂, Ca(NO₃)₂, and NbCl₅, and dissolving the powder in a 20 mL deionized (DI) water for obtaining a first solution;
(2) adding a solution of LiNO₃ (with 10% excess) into the first solution, wherein the LiNO₃, so as to obtain a second solution;
(3) adding NbCl₅ into the second solution, and then stirring the second solution under a temperature of 50° C. for 40 minutes, thereby obtaining a third solution;
(4) adding the third solution into a citric acid accommodated in a round-bottomed flask, and then adding ethylene glycol into the round-bottomed flask, so as to make that there is a mole ratio of the ethylene glycol to the citric acid, and the mole ratio is 1:1;
(5) letting a fourth solution obtained from the forgoing step (4) be applied with an oil bath treatment, and constantly stirring the fourth solution in case of a processing temperature being increased from 50° C. to 80° C.;
(6) applying an evaporation process to the fourth solution obtained from the forgoing step (5) for obtaining a transparent gel, and subsequently letting the transparent gel be further heated at 200° C. for 2 hours, thereby obtaining a powder; and
(7) applying a grinding process to the power obtained from the forgoing step (6), and then letting the powder be applied with a thermal treatment (sinter), thereby obtaining a LLCZN powder.

To complete a fabrication of the composite layer 1 of the present invention, it needs to let a raw material (powder or beads) of PVDF be dissolved in an organic solvent, and then add the LLCZN powder into the organic solvent, thereby obtaining a specific solution. It is worth explaining that, the forgoing organic solvent is prepared after mixing N-methyl-2-pyrrolidone (NMP) and acetone by a ratio of 4:1 (v/v). Moreover, there is a weight ratio of the PVDF to the LLCZN powder, and the weight ratio is in a range between 5:95 and 20:80. For example, content of the PVDF in the specific solution is 16 weight percent (wt %), and the LLCZN powder has content of 84 weight percent (wt %) in the specific solution. As a result, an electro-spinning apparatus is adopted for transforming the specific solution into a plurality of polymer fibers, and the plurality of polymer fibers further form a fibrous film on the copper current collector 24 of the lithium-based battery 2.

### Second Embodiment

In second embodiment, the composite layer 1 of the present invention further comprises a lithium salt, such that the composite layer 1 is characterized by comprising a first part by mass of the fibrous film and the inorganic additive occupy and a second part by mass of the lithium salt, so as to make that there is a ratio between the second part by mass and the first part by mass, and the ratio is in a range from 1:4 to 1:100. Briefly speaking, in second embodiment, the composite layer 1 comprises a fibrous film, an inorganic additive and a lithium salt. In a practicable embodiment, the lithium salt can be LiClO₄, and a ratio of the part by mass of the lithium salt LiClO₄ to the part by mass of the PVDF fibrous film and the LLCZN powder can be calculated to 20%.

Experiment I

There are 5 samples divided into a control group and an experimental group in experiment I. With reference to following Table (1), sample No. 1 is an anode free lithium metal battery (AFLMB) integrated with a PVDF fibrous film therein, and is put in the control group. On the other hand, samples No. 2, No. 3, No. 4, and No. 5 are all put in experimental group. As explained in more detail below, samples No. 2 is an AFLMB containing an experimental composite layer that comprises a PVDF fibrous film (80 wt %) and a lithium salt LiClO₄ (20 wt %), and sample No. 3 is an AFLMB containing an experimental composite layer that comprises a PVDF fibrous film (6 wt %) and a LLCZN powder (94 wt %). Moreover, sample No. 4 is an AFLMB containing the first embodiment of the composite layer 1 according to the present invention, and sample No. 5 is an AFLMB containing the second embodiment of the composite layer 1 according to the present invention. Form above descriptions, it should know that the first embodiment of the composite layer 1 of the present invention comprises a PVDF fibrous film (16 wt %) and a LLCZN powder (84 wt %). Moreover, the second embodiment of the composite layer 1 comprises a PVDF fibrous film (16 wt %), a LLCZN powder (84 wt %) and a lithium salt LiClO₄, wherein a ratio of the part by mass of the lithium salt LiClO₄ to the part by mass of the PVDF fibrous film and the LLCZN powder can be calculated to 20%.

TABLE 1

| | Samples | |
|---|---|---|
| | No. | Constitution of sample |
| Control group | 1 | AFLMB integrated with a PVDF fibrous film. |
| experimental | 2 | AFLMB containing an experimental composite |
| group | | layer that comprises a PVDF fibrous film (80 |
| | | wt %) and a lithium salt LiClO4 (20 wt %) |
| | 3 | AFLMB containing an experimental composite |
| | | layer that comprises a PVDF fibrous film (6 |
| | | wt %) and a LLCZN powder (94 wt %) |
| | 4 | AFLMB integrated with the first |
| | | embodiment of the composite layer |
| | | according to the present invention |
| | 5 | AFLMB integrated with the second |
| | | embodiment of the composite layer |
| | | according to the present invention |

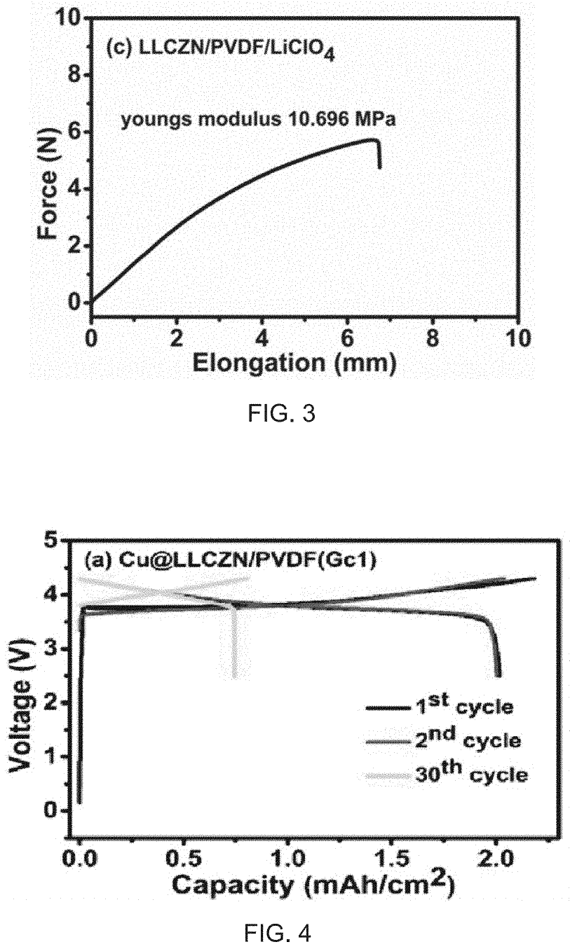

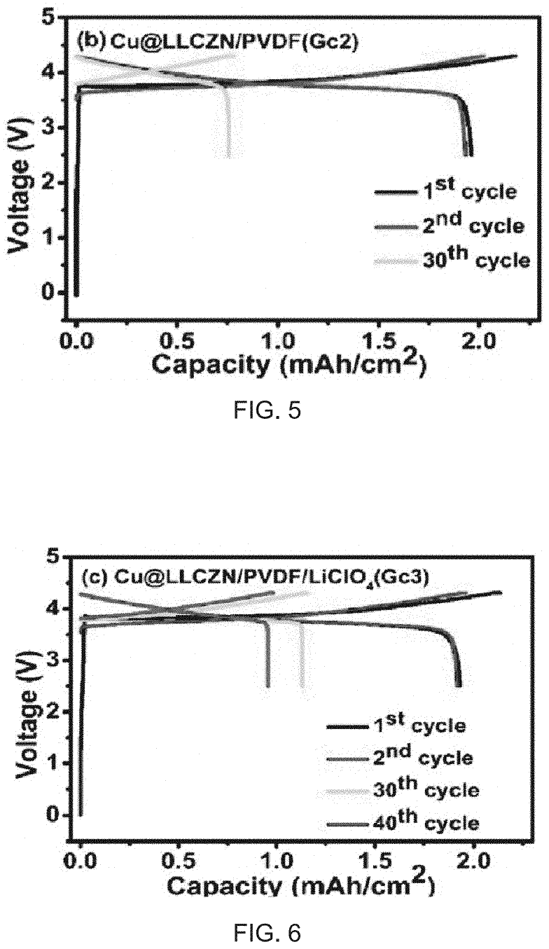

The FIG. 3 shows an experimental data plot of a tensile test of the second embodiment of the composite layer (i.e., sample No. 5). Experimental data presented by FIG. 3 have revealed that, the composite layer 1 comprising a PVDF fibrous film (16 wt %), a LLCZN powder (84 wt %) and a lithium salt LiClO₄ has a Young's modulus greater than 10.696 MPa. On the other hand, FIG. 4 shows a data plot of capacity versus voltage of a sample No. 3 of the lithium-based battery integrated with the composite layer, FIG. 5 shows a data plot of capacity versus voltage of a sample No. 4 of the lithium-based battery integrated with the composite layer, and FIG. 6 shows a data plot of capacity versus voltage of a sample No. 5 of the lithium-based battery integrated with the composite layer. Experimental data have proved that, sample No. 3 (Gc1) exhibits an initial areal charge capacity of 2.18 mAh/cm² and a gravimetric capacity of 188.7 mAh/g under a testing condition of 0.2 mA/cm² current density. Moreover, under the testing condition of 0.2 mA/cm² current density, sample No. 4 (Gc2) exhibits an initial areal charge capacity of 2.17 mAh/cm² and a gravimetric capacity of 188.37 mAh/g under a testing condition of 0.2 mA/cm². On the other hand, sample No. 5 (Gc3) exhibits an initial areal charge capacity of 2.13 mAh/cm² and a gravimetric capacity of 184.71 mAh/g under the same testing condition of 0.2 mA/cm² current density.

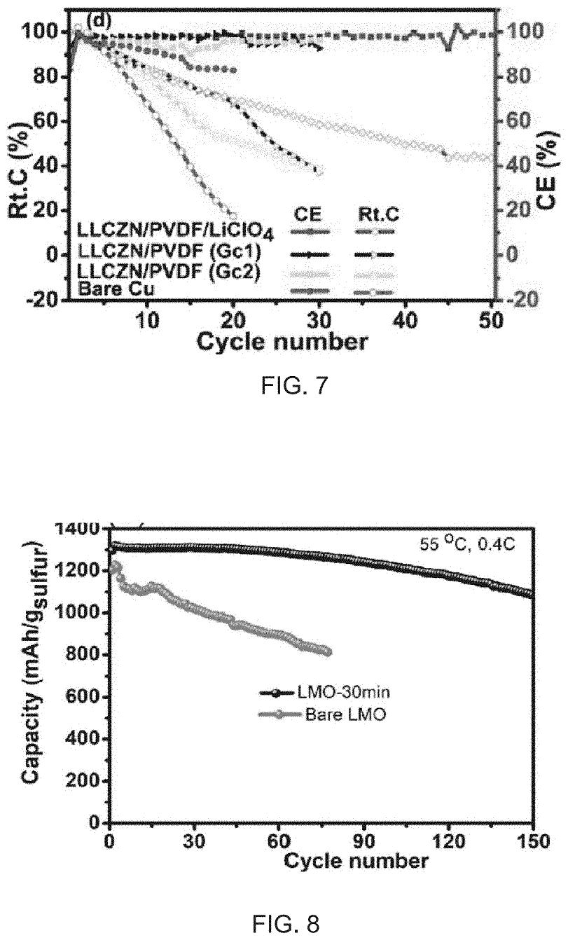

With reference to FIG. 7, there is shown an experimental data plot of an electrical test of the sample No. 3, the sample No. 4 and the sample No. 5. Experimental data of FIG. 7 have revealed that, the sample No. 5 (Gc3) still can exhibit a capacity retention (Rt. C) of 58.66% and an average coulombic efficiency of 97.6% after significant charge/discharge cycles are completed. However, after significant charge/discharge cycles are completed, sample No. 3 (Gc1) can merely exhibit a capacity retention (Rt. C) of 37.02% and an average coulombic efficiency 96.92%, and sample No. 4 (Gc2) can merely exhibit a capacity retention (Rt. C) of 38.57% and an average coulombic efficiency 94.88%. Consequently, experimental data have proved that, by letting an anode free lithium metal battery (AFLMB) be integrated with the composite layer 1 of the present invention, not only does the formation of lithium dendrite be significantly suppressed, but the decomposition of electrolyte is also effectively inhibited. Moreover, the most important thing is that, by letting the AFLMB be integrated with the proposed composite layer 1, capacity retention and coulombic efficiency of the AFLMB are both significantly enhanced.

### Third Embodiment

In the third embodiment, the composite layer 1 proposed by the present invention is applied in a lithium-ion battery, and is disposed on a lithium manganese oxide (LMO) cathode of the lithium-ion battery, so as to be used as a cathode-electrolyte interphase (CEI). In the third embodiment, the composite layer 1 comprises a fibrous film and an inorganic additive, wherein there is a weight ratio of the fibrous film to the inorganic additive, and the weight ratio being in a range between 5:95 and 20:80.

As described in more detail below, the fibrous film is made of a material selected from the group consisting of polyvinylidene fluoride (PVDF), polyacrylonitrile (PAN) and pyethylene oxide (PEO), and comprises a plurality of polymer fibers. On the other hand, the inorganic additive is a powder of cubic lithium garnet material, and is doped in the plurality of polymer fibers, or is enclosed in each of the plurality of polymer fibers, thereby making the composite layer 1 has a Young's modulus greater than 8 MPa.

In a practicable embodiment, the powder of cubic lithium garnet material (i.e., the inorganic additive) comprises a first inorganic material and a second inorganic material. In which, the first inorganic material can be Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials. On the other hand, the second inorganic material can be Al, Nb, Ca, Ta, Ga, Zr, or W. For instance, the powder of cubic lithium garnet material (i.e., the inorganic additive) is Li₇La_{2.75}Ca_{0.25}Zr_{1.75}Nb_{0.25}O₁₂ (LLCZN) or Li_{5.6}Ga_{0.26}La_{2.9}Zr_{1.87}Nb_{0.05}O₁₂ (LGLZNO). The processing flow for manufacturing the LLCZN powder has been introduced through above descriptions, such that the material engineers skilled in development and synthesis of cubic lithium garnet material should be able to complete the fabrication of a LGLZNO powder by referring the processing flow of the LLCZN powder.

To complete the fabrication of the third embodiment of the composite layer 1, it needs to let a raw material (powder or beads) of PVDF be dissolved in an organic solvent, and then add the LGLZNO powder into the organic solvent, thereby obtaining a specific solution. It is worth explaining that, the forgoing organic solvent is prepared after mixing N-methyl-2-pyrrolidone (NMP) and acetone by a ratio of 4:1 (v/v). Moreover, there is a weight ratio of the PVDF to the LGLZNO powder, and the weight ratio is in a range between 5:95 and 20:80. For example, content of the PVDF in the specific solution is 15 weight percent (wt %), and the LGLZNO powder has content of 85 weight percent (wt %) in the specific solution. As a result, an electro-spinning apparatus is adopted for transforming the specific solution into a plurality of polymer fibers, and the plurality of polymer fibers further form the composite layer 1 of the present invention.

Experiment II

There are 2 samples divided into a control group and an experimental group in experiment Ii. With reference to following Table (2), sample No. I is a Li-ion battery having a lithium manganese oxide (LMO) cathode, and is put in the control group. On the other hand, sample No. II is also a Li-ion battery having a LMO cathode. It is worth explaining that, sample No. II is further integrated with the third embodiment of the composite layer of the present invention, and is put in the experimental group. Form above descriptions, it should know that the third embodiment of the composite layer of the present invention comprises a PVDF fibrous film (15 wt %) and a LGLZNO powder (85 wt %).

TABLE 2

| | Samples | |
|---|---|---|
| | No. | Constitution of sample |
| Control group | I | Li-ion battery having a LMO cathode |
| experimental | II | Li-ion battery having a LMO cathode |
| group | | and a third embodiment of the composite |
| | | layer according to the present invention. |

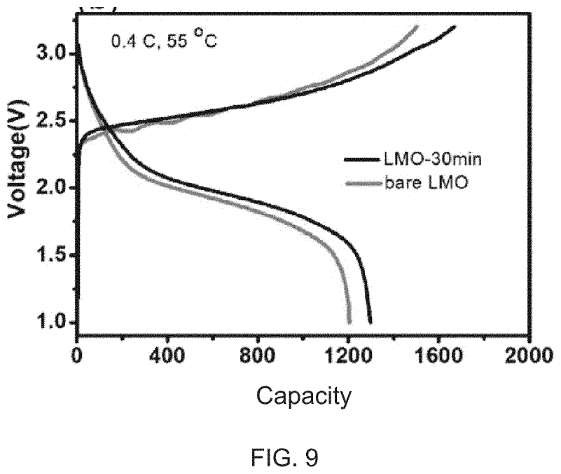

The FIG. 8 shows an experimental data plot of a charge/discharge cycle test of sample No. I and sample No. II, and FIG. 9 shows an experimental data plot of an electrical test of sample No. I and sample No. II. Experimental data have proved that, sample No. II (LMO-30 min) still has a capacity that is greater than 1000 mAh/g_{sulfur} after 150 cycles of charge/discharge testing are finished. Moreover, sample No. II (LMO-30 min) exhibits a capacity retention (Rt. C) of 77% under a low-rate (0.4 C rate) discharge. On the contrary, sample No. I (Bare LMO) merely has a capacity about 800 mAh/g_{sulfur} after 150 cycles of charge/discharge testing are finished. Moreover, sample No. I (Bare LMO) merely exhibits a capacity retention (Rt. C) of 45% under a low-rate (0.4 C rate) discharge. Therefore, it is able to calculate that the fading rate of the samples No. II and No. I are 0.023% and 0.0558%, respectively. Consequently, experimental data have proved that, by letting a Li-ion battery having a LMO cathode be integrated with the composite layer 1 of the present invention, not only does the formation of lithium dendrite be significantly suppressed, but the decomposition of electrolyte is also effectively inhibited. Moreover, the most important thing is that, by letting the Li-ion battery be integrated with the proposed composite layer 1, capacity retention and coulombic efficiency of the Li-ion battery are both significantly enhanced.

### Fourth Embodiment

In the fourth embodiment, the composite layer 1 proposed by the present invention comprises a fibrous film and an inorganic additive, wherein the fibrous film is made of polyethylene oxide (PEO). In other words, PEO is adopted for fabricating a Li-ion transport membrane (i.e., the fibrous film) in the fourth embodiment. More importantly, the PEO fibrous film coating reinforces a thin and robust solid electrolyte interface (SEI) formation via hosting lithium and regulating the inevitable reaction of lithium with electrolyte. On the other hand, the inorganic additive principally comprises a first inorganic material, and the first inorganic material can be Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials.

For example, the inorganic additive principally comprises lithium salt like LiNO₃ or LiClO₄. To complete the fabrication of the fourth embodiment of the composite layer, it needs to let a raw material (powder or beads) of PEO be dissolved in an organic solvent, and then add the lithium salt into the organic solvent, thereby obtaining a specific solution. It is worth explaining that, there is a weight ratio of the PEO to the lithium salt, and the weight ratio is in a range between 5:95 and 20:80. For example, content of the PEO in the specific solution is 15 weight percent (wt %), and the lithium salt has content of 85 weight percent (wt %) in the specific solution. As a result, an electro-spinning apparatus is adopted for transforming the specific solution into a plurality of polymer fibers for forming the composite layer.

When implementing the forth embodiment of the composite layer into a lithium-based battery 2, it needs to mix the forgoing specific solution with a electrolyte comprising 1M LiTFSI-DME/DOL and LiNO₃ (2 wt %) so as to for a mixture, and subsequently coat the mixture onto a copper current collector 24 of the lithium-based battery 2. It is worth explaining that, the forgoing 1M LiTFSI-DME/DOL is prepared after dissolving 1M LiTFSI in a solution of DME and DOL, wherein the solution of DME and DOL is prepared after mixing DME and DOL by a ratio of 1:1 (v/v). Moreover, the forgoing LiTFSI is an abbreviation of lithium bis(trifluoromethanesulfonyl)imide, the DME is an abbreviation of dimethoxyethane, and the DOL is an abbreviation of 1,2-dimethoxyethane

### Fifth Embodiment

In the fifth embodiment, the composite layer 1 proposed by the present invention comprises a fibrous film and an inorganic additive, wherein the fibrous film is made of polyacrylonitril (PAN), and the inorganic additive principally comprises a first inorganic material Al₂O₃. PAN is adopted for fabricating a Li-ion transport membrane (i.e., the fibrous film) in the fifth embodiment. More importantly, the PAN fibrous film coating reinforces a thin and robust solid electrolyte interface (SEI) formation via hosting lithium and regulating the inevitable reaction of lithium with electrolyte. To complete the fabrication of the fifth embodiment of the composite layer, it needs to let a raw material (powder or beads) of PAN be dissolved in an organic solvent, and then add the Al₂O₃ powder into the organic solvent, thereby obtaining a specific solution. It is worth explaining that, there is a weight ratio of the PAN to the Al₂O₃ powder, and the weight ratio is in a range between 5:95 and 20:80. For example, content of the PAN in the specific solution is 20 weight percent (wt %), and the Al₂O₃ powder has content of 80 weight percent (wt %) in the specific solution. As a result, an electro-spinning apparatus is adopted for transforming the specific solution into a plurality of polymer fibers, so as to form the composite layer on a copper current collector 24 of the lithium-based battery 2.

### Sixth Embodiment

In the sixth embodiment, the composite layer 1 proposed by the present invention comprises a fibrous film (45 wt %), an inorganic additive (0.01-10 wt %) and an organic material (45-55 wt %). In which, the fibrous film is made of a material, and the material can be polyvinylidene fluoride (PVDF), polyacrylonitrile (PAN) or polyethylene oxide (PEO). Moreover, the inorganic additive comprises a first material, and the first material can be Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials. On the other hand, the organic material is an oligomer with thermal polymerization property, such as monomaleimide, polymaleimide, bismaleimide, polybismaleimide, and copolymer of bismaleimide and monomaleimide. When implementing the sixth embodiment of the composite layer into a lithium-based battery 2, the composite layer is disposed on a copper current collector 24 of the lithium-based battery 2.

The above description is made on embodiments of the composite layer according to the present invention. However, the embodiments are not intended to limit scope of the present invention, and all equivalent implementations or alterations within the spirit of the present invention still fall within the scope of the present invention.

What is claimed is:

1. A composite layer for application in a lithium-based battery, comprising a fibrous film and an inorganic additive, wherein there is a weight ratio of the fibrous film to the inorganic additive, and the weight ratio being in a range between 5:95 and 20:80.

2. The composite layer of claim 1, wherein the fibrous film comprises a plurality of polymer fibers, and the inorganic additive is doped in the plurality of polymer fibers, or being enclosed in each of the plurality of polymer fibers, thereby making the composite layer has a Young's modulus greater than 8 MPa.

3. The composite layer of claim 2, further comprising a lithium salt, such that the composite layer is characterized by comprising a first part by mass of the fibrous film and the inorganic additive occupy and a second part by mass of the lithium salt, so as to make that there is a ratio between the second part by mass and the first part by mass, and the ratio being in a range from 1:4 to 1:100.

4. The composite layer of claim 2, wherein the lithium-based battery is an anode free lithium metal battery (AFLMB), and the composite layer being disposed on a current collector of the anode free lithium metal battery.

5. The composite layer of claim 4, wherein the current collector is made of a material that is selected from the group consisting of stainless steel, Cu, Al, Ag, alloy containing indium, and fluorine-doped tin oxide (FTO).

6. The composite layer of claim 2, wherein the lithium-based battery is a lithium-ion battery, and the composite layer being disposed on a lithium manganese oxide (LMO) cathode of the lithium-ion battery, so as to be used as a cathode-electrolyte interphase (CEI).

7. The composite layer of claim 2, wherein the fibrous film is made of a material that is selected from the group consisting of polyvinylidene fluoride (PVDF), polyacrylonitrile (PAN) and pyethylene oxide (PEO).

8. The composite layer of claim 2, further comprises an organic member, and the organic member being made of an oligomer with thermal polymerization property that is selected from the group consisting of monomaleimide, polymaleimide, bismaleimide, polybismaleimide, and copolymer of bismaleimide and monomaleimide.

9. The composite layer of claim 2, wherein the inorganic additive comprises a first material that is selected from the group consisting of Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials.

10. The composite layer of claim 9, wherein the inorganic additive further comprises a second material that is selected from the group consisting of Al, Nb, Ca, Ta, Ga, Zr, and W.

11. A lithium-based battery, characterized in that a composite layer is integrated in the lithium-based battery, and the composite layer comprising a fibrous film and an inorganic additive; wherein there is a weight ratio of the fibrous film to the inorganic additive, and the weight ratio being in a range between 5:95 and 20:80.

12. The lithium-based battery of claim 11, wherein the fibrous film comprises a plurality of polymer fibers, and the inorganic additive is doped in the plurality of polymer fibers, or being enclosed in each of the plurality of polymer fibers, thereby making the composite layer has a Young's modulus greater than 8 MPa.

13. The lithium-based battery of claim 12, wherein the composite layer further comprises a lithium salt, such that the composite layer is characterized by comprising a first part by mass of the fibrous film and the inorganic additive occupy and a second part by mass of the lithium salt, so as to make that there is a ratio between the second part by mass and the first part by mass, and the ratio being in a range from 1:4 to 1:100.

14. The lithium-based battery of claim 12, wherein the lithium-based battery is an anode free lithium metal battery (AFLMB), and the composite layer is disposed on a current collector of the anode free lithium metal battery.

15. The lithium-based battery of claim 14, wherein the current collector is made of a material that is selected from the group consisting of stainless steel, Cu, Al, Ag, alloy containing indium, and fluorine-doped tin oxide (FTO).

16. The lithium-based battery of claim 12, wherein the lithium-based battery is a lithium-ion battery, and the composite layer being disposed on a lithium manganese oxide (LMO) cathode of the lithium-ion battery, so as to be used as a cathode-electrolyte interphase (CEI).

17. The lithium-based battery of claim 12, wherein the fibrous film is made of a material that is selected from the group consisting of polyvinylidene fluoride (PVDF), polyacrylonitrile (PAN) and pyethylene oxide (PEO).

18. The lithium-based battery of claim 12, further comprises an organic member, and the organic member being made of an oligomer with thermal polymerization property that is selected from the group consisting of monomaleimide, polymaleimide, bismaleimide, polybismaleimide, and copolymer of bismaleimide and monomaleimide.

19. The lithium-based battery of claim 12, wherein the inorganic additive comprises a first material that is selected from the group consisting of Al₂O₃, LiPF₆, LiFSI, LiTFSI, LiBF₄, LiClO₄, LiNO₃, Li₂C₂O₄, Li₂O₂, Li₃N, LiN₃, and a mixture of two or more of the forgoing materials.

20. The lithium-based battery of claim 19, wherein the inorganic additive further comprises a second material that is selected from the group consisting of Al, Nb, Ca, Ta, Ga, Zr, and W.
